(19) United States
(12) Patent Application Publication
(10) Pub. No.: US 2019/0166894 A1
(43) Pub. Date: Jun. 6, 2019

(54) MEAT SNACK PRODUCT AND METHOD OF MAKING

(71) Applicant: SMITHFIELD PACKAGED MEATS CORP., Smithfield, VA (US)

(72) Inventors: Eric TENNANT, Suffolk, VA (US); Jeffrey WARNER, Carrollton, VA (US); Paul KAFER, Carrollton, VA (US); David TAYLOR, Smithfield, VA (US)

(21) Appl. No.: 16/272,317

(22) Filed: Feb. 11, 2019

Related U.S. Application Data
(62) Division of application No. 15/608,463, filed on May 30, 2017.
(60) Provisional application No. 62/343,387, filed on May 31, 2016.

(51) Int. Cl. A23L 13/60; A23J 3/04; A23J 3/26; A23P 30/30; A23L 13/40; A23L 13/00; A23L 13/20

(52) U.S. Cl. CPC A23L 13/67; A23J 3/04; A23J 3/26; A23P 30/30; A23L 13/428; A23L 5/34; A23L 13/03; A23L 13/20; A23L 13/65; A23L 13/424; A23L 13/62

(57) ABSTRACT

A cooked slice of a meat mass formed of a ground meat mixture and expanded pellets of cellular material provides a crispy, light meat snack product. In some embodiments, the pellets are rendered skin having a low pre-expansion moisture content. A method of making the meat snack product includes making a meat form by adding pellets of cellular material having a moisture content of less than 10% by weight to a ground meat mixture, batch cooking, chilling and slicing the meat form, and cooking the slices of the meat form to expand the pellets of cellular material to result in a crispy meat form slice.

### RELATED APPLICATIONS

This application is a division of U.S. application Ser. No. 15/608,463 filed May 30, 2017, which itself claims the benefit of, and priority to, U.S. App. No. 62/343,387 filed May 31, 2016, all of which are hereby incorporated by reference in their entirety.

### FIELD OF THE INVENTION

This application is directed to a snack product and more particularly to a meat snack product and a method of making that meat snack product.

### BACKGROUND OF THE INVENTION

Snacking has become an increasingly important and diverse segment of the consumer food industry. A variety of many different factors may play into growing consumer demand. In some cases, for example, consumers are eating smaller and/or fewer meals throughout the day, and thus may experience hunger more frequently, causing them to seek snack products. In other cases, consumers simply want more variety. Yet another contributing factor is the increasing popularity of consumer demand for snacks that are seen as compatible with high protein/low carbohydrate diets, in which traditional snacks such as potato chips and pretzels are less readily consumed.

Meat snacks provide a high protein/low carbohydrate snack source. While satisfying, traditional meat snacks tend to be dense and heavy. A need remains to provide consumers with snacks of varying textures and eating experiences and it would be desirable to provide a meat snack product having a lighter texture that contrasts with that of more traditional meat sticks and other meat snacks.

### BRIEF DESCRIPTION OF THE INVENTION

Exemplary embodiments are directed to a snack food product comprising a crisped meat log or other slice of formed meat mass comprising a ground meat mixture and expanded pellets of cellular material. In some embodiments, the pellets are rendered skin pellets, such as rendered pork skin pellets.

According to one exemplary embodiment, a snack food product comprises a crisped slice of a meat form that comprises at least 80% by weight of a ground meat mixture and expanded pellets of rendered skin having a pre-expanded moisture content of about 5% to about 6% by weight.

According to another exemplary embodiment, a meat form comprises a ground meat mixture and up to 50% by weight, such as 5% to 25% by weight, rendered skin pellets, the pellets having a moisture content of less than 10% by weight and a surface area less than 10 cm².

According to yet another embodiment of the invention, a method of making a snack food product comprises making a meat form comprising adding pellets of cellular material having a moisture content of less than 10% by weight to a ground meat mixture and stuffing the ground meat mixture containing the pellets of cellular material into a casing with the meat form being about 5% to about 25% by weight of the pellets. The method further includes batch cooking and chilling the meat form, slicing the meat form after removing its casing and then cooking the slices of the meat form to expand the pellets of cellular material and form a crispy meat form slice.

Among the advantages of exemplary embodiments is that a snack is provided that is primarily or entirely meat, but, has a lighter texture than traditional meat snacks.

Another advantage is that in some embodiments, a meat snack is created that reduces waste by employing ingredients rejected from incorporation into other snack production because of their size.

Still another advantage is that exemplary embodiments introduce air into the product through the expansion of pellets of skin or other cellular material during the cooking process.

Yet another advantage is that the introduction of skin pellets adds protein that has nutritional benefit.

Other features and advantages of the present invention will be apparent from the following more detailed description of exemplary embodiments that illustrate, by way of example, the principles of the invention.

### BRIEF DESCRIPTION OF THE DRAWINGS

FIG. 1 is an expandable pellet for use in accordance with exemplary embodiments.

FIG. 2 is a meat form containing expandable pellets in accordance with an exemplary embodiment.

FIG. 3 are meat snacks in accordance with exemplary embodiments in which the pellets in the slices of meat form have been expanded during cooking.

### DETAILED DESCRIPTION OF EXEMPLARY EMBODIMENTS

Exemplary embodiments are directed to a meat based snack food product and methods for making them and which provide a snack having, among other advantages, a lighter texture than traditional meat snacks through the incorporation of a pellet that expands (i.e., pops) when cooked.

Exemplary embodiments begin with formation of a ground meat mixture for use in creating a meat form, such as a meat log or other form of meat mass. The ground meat mixture may be formed according to any recipe and encompasses traditional methods and recipes of making cased meat log products, including the types of meats and spices typically used in creating such products, all of which will be appreciated by those of ordinary skill in the art. Exemplary ground meat mixtures include ground bacon mixtures as well as those used in creating pepperoni, chorizo, andouille, and other cured sausages, for example.

While discussed primarily herein with respect to ground meat mixtures that include pork, it will be appreciated that the invention is not so limited and that other desired meat sources may be used alone, or in combination with pork or one another. Other exemplary meats in addition to pork include, but are not limited to, beef, venison, buffalo, lamb, and goat, as well as emu, poultry and other fowl, and may also include fish and other seafood products.

Generally, meat log formation includes grinding and blending one or more meats in combination with salt and one or more additional seasonings, the ground meat mixture typically having a fat content of 25% to 35% by weight. Depending on the fat content of the animal flesh used for the ground-meat mixture, direct of addition of fat through the introduction of pork bellies, blade trim, and/or other sources of fat may also be added to the ground meat mixture to achieve the desired fat content. These additional sources of fat may be of the same meat source as the main flesh used in forming the ground meat mixture or may be from a different animal. The non-meat ingredients such as salt and other seasonings may be added in amounts up to about 4% by weight of the ground meat mixture, typically up to about 2% by weight, such as about 1.25% to about 1.5% by weight.

The blending and grinding may be accomplished by any commercial grinding equipment, such as a paddle/ribbon type blender or bowl chopper, for example. In some embodiments, the meat may be chilled to use frozen meat for some or all of the meat block. For example, a flaker may be provided and/or CO2 chilling may be used. Generally, processing the meat at temperatures less than 30° F. (−1° C.) is desirable to reduce liquefaction of fat.

The initial blending and grinding of the ground meat mixture may thus be carried out at temperatures either below or above freezing to the desired final grind size, which in some embodiments is through a 0.25 inch (6.35 mm) plate.

After grinding is complete, expandable pellets of cellular material are blended into the ground meat mixture. The pellet may be of any cellular material that can be expanded to pop upon application of heat during cooking. In order to exhibit the desired level of expansion, the pellets typically have a moisture content of less than 10% by weight at incorporation and prior to expansion. It will be appreciated that the pellets may partially rehydrate during processing to something slightly greater than the moisture content at introduction as a result of absorbing moisture from the ground meat mixture in which the pellets are distributed.

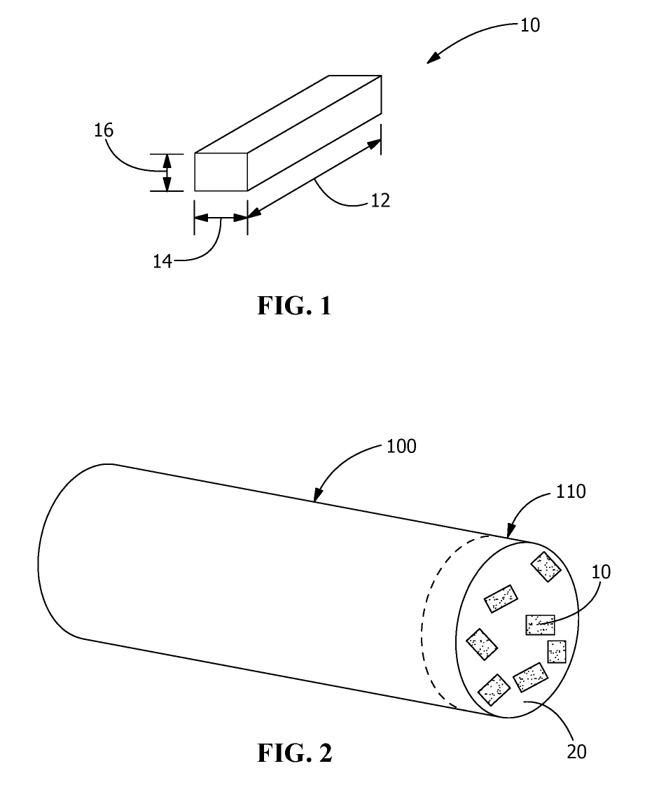

In some embodiments, with respect to FIG. 1, pellets 10 have a pre-expansion geometry consistent with a rectangular prism, having a length 12, width 14 and thickness 16. To aid in processing of subsequent steps of forming the crispy meat snack product, the pellets 10 typically have a thickness 16 of about 0.125 in. or less, but greater than about 0.0625 in. at the time of their incorporation although it will be appreciated that the pellet thickness may be greater or smaller than within this range and will depend at least somewhat on the desired thickness of the slices formed during subsequent processing. Additionally, the pellets at the time of introduction into the ground meat mixture may have a surface area less than about 1.55 in² (10 cm²), such as between about 0.78 in² (0.5 cm²) and 1.24 in² (8 cm²), although larger surface areas are not precluded. It will be appreciated that surface area is nominal based on macroscopic geometry of the pellet and is not intended to be inclusive of pores, etc.

The pellet may be rendered skin, preferably rendered pork skin, although other expandable cellular materials, such as rice and corn as well as other rendered skin sources, for example, may also be used alone or in combination with one another. In some embodiments, pellets of rendered poultry skin (e.g. chicken and/or turkey) may be used.

Pellets of rendered pork skin are a dry, hard material and are rendered to a moisture content in the range of about 5 to about 6 percent by weight. Among the advantages of using rendered pork skin as the expandable pellets are that pellets of a suitable size as described herein are generally readily available from what would otherwise be a waste stream, with pellets of this size being rejected as too small for use in production of pork rind snacks. Additionally, using rendered pork skin as the pellets also allows the production of a snack that is, with the exception of salt or other seasonings, an all meat snack. This permits some exemplary embodiments to be manufactured free of grain based fillers such as wheat flour, corn flour, or other grains. The ability to form products that exclude wheat and other grain fillers means that gluten-free snack products can also be provided.

It will be appreciated, however, that embodiments which include grains, as well as those which include flour made from grain or any other foodstuff are also contemplated. Thus, exemplary embodiments may also include one or more non-meat fillers added to the ground meat mixture, including wheat flour, corn flour, nut flour, and bean flour all by way of example only.

The pellets should be added after final grinding of the ground meat mixture to prevent further reduction in size of the pellets by the grinder that may reduce the effectiveness of pellet expansion during subsequent processing steps. The pellets may be added to the ground meat mixture such that the pellets are present up to about 50% by weight relative to the amount of the ground meat mixture, such as between about 5% and 25% by weight, more typically about 10% to about 20% by weight and in some embodiments, between about 12% and about 15% by weight. The ultimately formed meat snack product after cooking remains about 80% or more by weight ground meat mixture, although the expansion of the pellets may mean the relative volume of the ground meat mixture may be well less than that amount.

With reference to FIG. 2, after the pellets are fully incorporated into the ground meat mixture, the resulting blend is formed into a meat log 100 containing the pellets 10 suspended in the ground meat mixture 20. The pellets 10 remain suspended in the ground meat mixture 20 of the meat log 100 throughout additional processing steps, such as batch cooking, chilling, and slicing the log 100 to form slices 110, as well as thereafter cooking the slices 110.

In some embodiments the meat log is formed by stuffing the blend into a casing. It will further be appreciated that any size and type of casing may be used. In some embodiments, for example, stuffing may employ a vacuum stuffer and small horns and may use shined, cut stock or fibrous casing. Casings less than 75 mm in diameter may be preferred in order to produce a crispy meat snack product that can be consumed in one or just a few bites, similar to other hand-to-mouth snacks like potato chips.

In other embodiments, the meat log may be formed without a casing, such as by extrusion of the mass into an elongate form of any shape, including a meat log of a cylindrical or other cross-sectional shape, as well as extrusion into a sheet or other planar format for subsequent slicing. Thus, it will be appreciated that while primarily described herein with respect to a meat log, a variety of other meat forms are also contemplated for subsequent processing steps, including thermal processing and slicing as further described herein.

The incorporation of the pellets in their unexpanded form prior to cooking and other processing allows for the production of a snack having a light texture after cooking that is not achieved by other meat snacks. In fact, creating a meat snack product with incorporated air, and particularly doing so from a meat log, is contrary to the ordinary goal in sausage manufacture of trying to ensure all air is removed. Exemplary embodiments do the opposite, introducing air as a result of the final cooking step.

Once the meat log is formed, subsequent processing includes batch cooking of the meat log and may include one or more curing steps such as smoking or fermentation. For example, in some embodiments, the meat log may be smoked while in others it may undergo aging to carry out a salt cure.

After the meat logs are formed and batch cooked, the meat logs are sliced. In order to form more consistent slices, the meat logs are typically first chilled to below freezing, such as to a temperature in the range of about 18 to about 30° F. (about −8 to about −1° C.), such as about 20 to about 25° F. (about −7 to about −4° C.) in some embodiments, which may depend upon the particular meat mixture and the salt content thereof. Additionally, any casing may be removed prior to slicing; casing removal may occur prior to or after any chilling step.

The uncased, chilled meat log is sliced prior to cooking. Slice thickness may vary, but in some embodiments, the meat log is sliced at a thickness of up to about 24 or 25 slices per inch, typically between 14 and 24 slices per inch, such as about 16 to about 18 slices per inch. Slices thinner than about 25 per inch may result in the pellets falling out prior to or during cooking, while slices thicker than 14 per inch may increase difficulty in achieving a consistent crispy texture throughout the product and in getting the pellets to expand. Slicing may be accomplished using any slicing tool, but preferably takes place using a industrial processing meat slicer with a rotating blade.

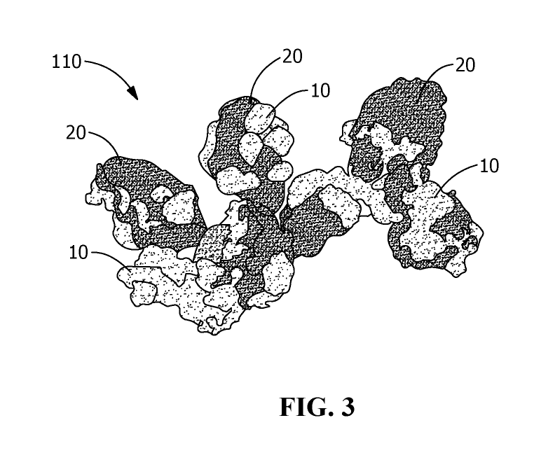

The slices of the meat log are then cooked at a temperature and for a time sufficient to produce a crispy meat snack product and expand (i.e., pop) the pellets as shown in FIG. 3, which illustrates a meat log slice 110 post-cooking in which the now pellets 10 have been expanded as a result of the cooking process that also cooks the cooked ground meat mixture 20. Meat snack products in accordance with exemplary embodiments have a water activity less than 0.85, and in some embodiments have a water activity of about 0.5, typically ranging between 0.48 and 0.52.

Although cooking options are not so limited, the meat log slices in accordance with some exemplary embodiments are cooked by one or more of frying, radiation (e.g. microwaving) and/or infrared (IR) to both pop the pellets and crisp the ground meat mixture in a single cooking step. The amount of time needed for microwave cooking may depend on a variety factors including wattage of the microwave. For industrial continuous microwave ovens, the product may be cooked to achieve about a 28-30% cook yield in order to produce crispy slices. For embodiments which employ frying, the slices may be cooked in 375° F. (191° C.) oil for a time between about 30 and 120 seconds, which may be accomplished, for example, using an industrial continuous frying system.

After cooling, the cooked slices are then ready for packaging; despite the low water activity, it may be desirable to vacuum pack or gas flush the packaging or otherwise provide a modified atmosphere packaging to limit the amount of oxygen in direct contact with the packaged product.

### EXAMPLES

The invention is further described in the context of the following examples which are presented by way of illustration, not of limitation.

### Example 1

Bacon chips were formed by grinding pork bellies and blade trim to a final grind size using a 0.25 in. plate and mixed with salt, sugar, and other non-meat bacon ingredients. Rendered pork skin pellets having a moisture content of between 5% and 6% by weight and having a thickness of about 0.125 in (3.175 mm) were mixed into the ground meat mixture, with the pellets added to be 12-15% by weight of the ground meat mixture. The resulting blend was stuffed into a 48 mm fibrous casing to form a meat log and smoked using a typical bacon cycle.

The meat log was chilled to between 23 and 25° F. (−5 and −4° C.), the casing removed, the meat log then sliced at a thickness of 16 slices per inch. The resulting slices were microwaved for 60 to 90 seconds, which resulted in the ground meat mixture crisping and the pellets popping under the heat and time of cooking to produce a meat snack product having a crispy but light texture that was, with the exception of seasoning, 100% meat and free of any grain based fillers.

### Example 2

Sausage chips were formed by grinding pork shoulder, pork bellies and blade trim to a final grind size using a 0.25 in (6.35 mm) plate and mixed with salt, paprika, garlic and other non-meat sausage ingredients. Rendered pork skin pellets having a moisture content of between 5% and 6% by weight and having a thickness of about 0.125 in (3.175 mm) were mixed into the ground meat mixture, with the pellets added to be 12-15% by weight of the ground meat mixture. The resulting blend was stuffed into a 48 mm fibrous casing to form a meat log and batch cooked.

The meat log was chilled to between 23 and 25° F. (−5 and −4° C.), the casing removed, the meat log then sliced at a thickness of 16 slices per inch. The resulting slices were microwaved for 60 to 90 seconds, which resulted in the ground meat mixture crisping and the pellets popping under the heat and time of cooking to produce a meat snack product having a crispy but light texture that was, with the exception of seasoning, 100% meat and free of any grain based fillers.

### Example 3

Pepperoni chips were formed by grinding pork trim and beef trim to a final grind size using a 0.25 in (6.35 mm) plate and mixed with salt, pepper, dextrose, paprika, and other non-meat pepperoni ingredients. Rendered pork skin pellets having a moisture content of between 5% and 6% by weight and having a thickness of about 0.125 in (3.175 mm) were mixed into the ground meat mixture, with the pellets added to be about 12-15% by weight of the ground meat mixture. The resulting blend was stuffed into a 48 mm fibrous casing to form a meat log and fermented using a typical pepperoni cycle.

The meat log was chilled to between 23 and 25° F. (−5 and −4° C.), the casing removed, the meat log then sliced at a thickness of 16 slices per inch. The resulting slices were microwaved for 60 to 90 seconds, which resulted in the ground meat mixture crisping and the pellets popping under the heat and time of cooking to produce a meat snack product having a crispy but light texture that was, with the exception of seasoning, 100% meat and free of any grain based fillers.

### Example 4

Ham chips were formed by grinding ham trim to a final grind size using a 0.25 in. plate and mixed with salt, sugar, and other non-meat ham ingredients. Rendered pork skin pellets having a moisture content of between 5% and 6% by weight and having a thickness of about 0.125 in (3.175 mm) were mixed into the ground meat mixture, with the pellets added to be 12-15% by weight of the ground meat mixture. The resulting blend was stuffed into a 48 mm fibrous casing to form a meat log and batch cooked using a typical ham cycle.

The meat log was chilled to between 23 and 25° F. (−5 and −4° C.), the casing removed, the meat log then sliced at a thickness of 16 slices per inch. The resulting slices were microwaved for 60 to 90 seconds, which resulted in the ground meat mixture crisping and the pellets popping under the heat and time of cooking to produce a meat snack product having a crispy but light texture that was, with the exception of seasoning, 100% meat and free of any grain based fillers.

While the foregoing specification illustrates and describes exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A snack food product comprising a crisped slice of a ground meat mixture and expanded pellets of cellular material.

2. The snack food product of claim 1, wherein the expanded pellets of cellular material comprises rendered animal skin, the pellets having a pre-expanded moisture content of less than 10% by weight.

3. The snack food product of claim 2, the expanded pellets comprising rendered pork skin and having a pre-expanded moisture content in the range of about 5% to about 6% by weight.

4. The snack food product of claim 1 comprising at least 80% by weight ground meat mixture.

5. The snack food product of claim 1, wherein the ground meat mixture has a fat content of about 25% to about 30% by weight.

6. The snack food product of claim 1, wherein the ground meat mixture comprises pork.

7. The snack food product of claim 1, wherein the snack food product is free of grain based filler.

8. The snack food product of claim 1, wherein the snack food product is gluten free.

9. The snack food product of claim 1, wherein the pellets of cellular material have a pre-expanded surface area of less than 10 cm².

10. The snack food product of claim 1, wherein the pellets of cellular material have a pre-expanded thickness of about 0.125 in. (3.175 mm) or less.

11. The snack food product of claim 1, wherein the snack food product further comprises a non-meat filler.

12. The snack food product of claim 11, wherein the non-meat filler comprises wheat flour, corn flour, nut flour, bean flour or combinations thereof.

13. The snack food product of claim 1, wherein the expanded pellets of cellular material are rendered animal skin and wherein the snack food product is free of non-meat filler.

14. The snack food product of claim 1, wherein a thickness of a pre-crisped slice ranges from 14 to 25 slices per inch.

15. A snack food product comprising a crisped meat form slice comprising at least 80% by weight of a ground meat mixture and expanded pellets of rendered pork skin having a pre-expanded moisture content of about 5% to about 6% by weight.
